(19) United States
(12) Patent Application Publication
(10) Pub. No.: US 2025/0030010 A1
(43) Pub. Date: Jan. 23, 2025

(54) ELECTRODE MATERIAL FOR FUEL CELLS, MEMBRANE ELECTRODE ASSEMBLY FOR FUEL CELLS, AND FUEL CELL

(71) Applicant: TOYO UNIVERSITY, Tokyo (JP)

(72) Inventor: Mika GAMO, Saitama (JP)

(73) Assignee: TOYO UNIVERSITY, Tokyo (JP)

(21) Appl. No.: 18/580,811

(22) PCT Filed: Jul. 8, 2022
(86) PCT No.: PCT/JP2022/027102

§ 371 Date: Jan. 19, 2024

(30) Foreign Application Priority Data
Jul. 27, 2021 (JP) 2021-122232

(51) Int. Cl. H01M 4/92; H01M 4/88; H01M 8/1004

(52) U.S. Cl. CPC H01M 4/926; H01M 4/8807; H01M 8/1004

(57) ABSTRACT

The present invention relates to a novel electrode material for fuel cells, and more particularly, to an electrode material for fuel cells, the electrode material comprising carbon fibers, in which the carbon fibers are carbon fibers covered with fibrous nanocarbon that supports a catalyst metal.

### TECHNICAL FIELD

The present invention relates to an electrode material used for fuel cells, and a membrane electrode assembly and a fuel cell using the electrode material.

### BACKGROUND ART

The fuel cell is a device that electrochemically and directly converts chemical energy of fuel such as hydrogen or methanol into electric energy without converting the chemical energy into heat. Since a fuel cell uses hydrogen and oxygen as raw materials and generates only electric power, water, and heat during power generation, the fuel cell has attracted attention as an environmentally friendly energy conversion device.

The fuel cell is classified into a polymer electrolyte fuel cell (PEFC), a phosphoric acid fuel cell (PAFC), an alkaline electrolyte fuel cell (AFC), a molten carbonate fuel cell (MCFC), a solid oxide fuel cell (SOFC), a direct methanol fuel cell (DMFC), and the like depending on the type of electrolyte or fuel. In particular, PEFC has high power generation efficiency even in a low-temperature operation, and is thus expected to be put into practical use and spread in applications such as automobiles, houses, and mobile devices.

However, in a fuel cell that can be used in a low-temperature operation, it is required to use a noble metal such as platinum as a catalyst for the purpose of accelerating a reaction at the electrode. Therefore, in order to obtain a high catalytic ability with a small amount, a technology of reducing a particle diameter of the noble metal or causing an electrode material to support the noble metal in a state of a high dispersion density has been developed.

Here, a carbon material is used as a catalyst support in a fuel cell, and the amount or utilization rate of the supported catalyst metal can be controlled by selecting the carbon material, and thus, it is desired to develop a carbon material having characteristics that can improve the performance of the electrode catalyst.

The present inventor has proposed a technology of using marimo carbon, which is a carbon material, as a catalyst support for fuel cells in JP 5854314 B2 (Patent Literature 1). Marimo carbon is a carbon material in which carbon nanofilaments (CNFs) grow radially and isotropically from diamond fine particles as a nucleus and have a form of marimo-like spherical fine particles. CNFs constituting marimo carbon have high crystallinity, and have a fibrous structure formed by stacking cup-shaped (or conical) graphene with graphene as a constituent unit. Patent Literature 1 shows that platinum particles are effectively supported using this marimo carbon. Therefore, the marimo carbon is expected as a catalyst support in place of an amorphous carbon material such as activated carbon or carbon black.

### CITATION LIST

### Patent Literature

Patent Literature 1: JP 5854314 B2

### SUMMARY OF INVENTION

### Technical Problem

On the other hand, the present inventor has conducted studies on practical use of marimo carbon as a catalyst support, and there was a problem that a process was complicated in producing constituent members of a fuel cell because marimo carbon was apparently a powder.

An important basic structure in a polymer electrolyte fuel cell comprises a pair of electrodes and an electrolyte disposed between the electrodes, and when a fuel cell is produced, a membrane electrode assembly (MEA) in which an electrode and an electrolyte membrane are integrated is usually used. The MEA of the PEFC is produced by attaching an anode (negative electrode) and a cathode (positive electrode) to each surface of a polymer electrolyte membrane. Here, the electrode comprises an electrode catalyst layer that is in contact with the electrolyte membrane to cause an electrode reaction, and a gas diffusion layer for feeding hydrogen or oxygen to the electrode catalyst layer is installed outside the electrode catalyst layer. Note that in the present specification, the electrode of the fuel cell refers to an electrode catalyst layer, and the gas diffusion layer is a member distinguished from the electrode, although the gas diffusion layer is also referred to as an electrode.

In a case where the MEA is produced using a powdered carbon material such as marimo carbon as a catalyst support, first, a catalyst metal such as platinum is supported on a powdered support (marimo carbon or the like) to prepare an electrode catalyst. Then, the obtained electrode catalyst is mixed with a proton conductive material (ionomer or the like) to form a slurry, the obtained slurry is sprayed on a Teflon sheet or the like to form a sheet, and the sheet-like molded product is pressure-bonded and transferred to an electrolyte membrane, and thus, an MEA in which electrode catalyst layers (electrodes) and an electrolyte membrane are integrated can be produced. Then, a carbon paper (carbon fiber paper: CFP) or the like is further pressure-bonded as a gas diffusion layer onto the electrode catalyst layers of the obtained MEA. As described above, the fact that the catalyst support is a powder contributes to complicating the production process, and simplification of the process is required.

In addition, since marimo carbon is spherical fine particles having a size of 10 μm or more in which CNFs are densely aggregated, it was difficult to diffuse (supply) the raw material gas (hydrogen or oxygen) into the inside the marimo carbon, and it was also difficult to diffuse (remove) a reaction product (water) generated inside of the marimo carbon. Further, it was difficult to allow the proton conductive material to permeate the inside of the marimo carbon, and it was also a problem to secure proton conductivity inside the marimo carbon. Therefore, there is room for further improvement in using marimo carbon as a carbon material for effectively performing an electrode reaction.

Therefore, an object of the present invention is to provide a novel electrode material for fuel cells by a technology different from the conventional technology. In addition, another object of the present invention is to provide a membrane electrode assembly and a fuel cell using the electrode material.

### Solution to Problem

In order to achieve the above object, the present inventor has studied use of a carbon composite material obtained by depositing fibrous nanocarbon on a base material comprising carbon fibers as a catalyst support instead of marimo carbon. In the base material used for the carbon composite material, since spaces are formed between the carbon fibers, fibrous nanocarbon can be formed even inside the base material, and diffusion (supply) of a raw material gas into the base material and diffusion (removal) of a reaction product from the inside of the base material are easy. In the case of such a carbon composite material, it is also easy to impart proton conductivity to the inside of the base material by dropping a proton conductive material or immersing the carbon composite material in the proton conductive material. In addition, since the carbon composite material is not a powder and can be directly stacked on the electrolyte membrane, simplification of the production process of the MEA can also be achieved. As described above, the present inventor has found that a carbon composite material in which fibrous nanocarbon is formed on a base material comprising carbon fibers is suitable as a catalyst support for fuel cells, thereby accomplishing the present invention.

Therefore, a first aspect of the present invention is an electrode material for fuel cells, the electrode material comprising carbon fibers, in which the carbon fibers are carbon fibers covered with fibrous nanocarbon that supports a catalyst metal.

In a preferred embodiment of the electrode material for fuel cells of the present invention, the carbon fibers covered with fibrous nanocarbon that supports a catalyst metal are further covered with a proton conductive material.

In addition, a second aspect of the present invention is a membrane electrode assembly for fuel cells comprising a pair of electrode catalyst layers, and an electrolyte membrane disposed between the electrode catalyst layers, in which at least one of the pair of electrode catalyst layers contains the electrode material according to the first aspect of the present invention.

In a preferred embodiment of the membrane electrode assembly for fuel cells of the present invention, the electrolyte membrane is a proton conductive polymer membrane.

In addition, a third aspect of the present invention is a fuel cell comprising a pair of electrode catalyst layers, and an electrolyte disposed between the electrode catalyst layers, in which at least one of the pair of electrode catalyst layers contains the electrode material according to the first aspect of the present invention.

In addition, a fourth aspect of the present invention is a fuel cell comprising the membrane electrode assembly according to the second aspect of the present invention.

In a preferred embodiment of the fuel cell of the present invention, the electrode catalyst layer containing the electrode material is an electrode catalyst layer having a gas diffusion function.

### Advantageous Effects of Invention

According to the first aspect of the present invention, a novel electrode material for fuel cells can be provided. According to the second to fourth aspects of the present invention, a membrane electrode assembly and a fuel cell using the electrode material can be provided.

### BRIEF DESCRIPTION OF DRAWINGS

FIG. 1 illustrates an SEM image of a CFP (upper side) and an SEM image of CNFs/CFP (lower side).

FIG. 2 illustrates a TEM image of CNFs.

FIG. 3 illustrates a relationship between the amount of fibrous nanocarbon deposition (carbon deposition amount) and a synthesis temperature.

FIG. 4 illustrates SEM images of CNFs/CFP, in which (a) illustrates a surface of CNFs/CFP, and (b) illustrates a cross section of CNFs/CFP.

FIG. 5 illustrates fiber diameter distributions of CNFs synthesized at 450° C. and 550° C., (a) is the case of 450° C. and (b) is the case of 550° C.

FIG. 6 illustrates volume resistivities of CFP and CNFs/CFP.

FIG. 7 illustrates an SEM image of Pd/CNFs/CFP (a) and an SEM image of Pd/CFP (b).

FIG. 8 illustrates an SEM image of Pd/CFP.

FIG. 9 illustrates an SEM image of Pd/CNFs/CFP.

FIG. 10 illustrates a comparison of reactivities of Pd/CNFs/CFP and Pd/CFP with hydrogen.

### DESCRIPTION OF EMBODIMENTS

Hereinafter, the present invention will be described in detail.

One aspect of the present invention is an electrode material for fuel cells, the electrode material comprising carbon fibers, in which the carbon fibers are carbon fibers covered with fibrous nanocarbon that supports a catalyst metal. In the present specification, the electrode material for fuel cells is also referred to as “electrode material of the present invention”.

The electrode material of the present invention comprises a material comprising carbon fibers. The material comprising carbon fibers is an aggregate of a plurality of carbon fibers, and has a function as a support of fibrous nanocarbon that supports a catalyst metal in the present invention. Therefore, the material comprising carbon fibers can be referred to as a base material. In addition, the base material has spaces formed between the carbon fibers, and is also referred to as a porous base material. As described above, even inside the base material, fibrous nanocarbon that supports a catalyst metal can be supported by using a base material in which spaces are formed between carbon fibers. A thickness of the base material is preferably 0.15 to 0.4 mm.

The material comprising carbon fibers is preferably a planar material for use as the electrode material for fuel cells. Specific examples of the material comprising carbon fibers include a carbon fiber woven fabric, a carbon fiber paper sheet, a carbon fiber nonwoven fabric, a carbon felt, a carbon paper (carbon fiber paper: CFP), and a carbon cloth. Among them, a CFP is preferable.

The carbon fibers constituting the base material is a support of fibrous nanocarbon, and thus has a diameter larger than that of fibrous nanocarbon, and usually has a diameter on the order of micrometers. For example, a diameter of a monofilament of the carbon fiber is 5 to 10 μm. The diameter of the monofilament of the carbon fiber can be determined according to JIS R7607:2000.

A gas permeability of the material comprising carbon fibers is preferably 100 to 10,000 ml·mm/(cm²·hr·mmAq), more preferably 500 to 5,000 ml·mm/(cm²·hr·mmAq), and most preferably 1,000 to 3,000 ml·mm/(cm²·hr·mmAq). In the present specification, the gas permeability can be measured by an isobaric method according to JIS K 7126-2. As a test gas, oxygen gas is used.

In the electrode material of the present invention, the carbon fibers are covered with fibrous nanocarbon that supports a catalyst metal. Here, the “carbon fibers are covered with fibrous nanocarbon” means that the entire or some carbon fibers are covered with fibrous nanocarbon. Specific examples thereof include an aspect in which some of all carbon fibers are entirely or partially covered with fibrous nanocarbon, and an aspect in which all carbon fibers are entirely or partially covered with fibrous nanocarbon. In the electrode material of the present invention, it is preferable that the entire carbon fibers constituting the base material are uniformly covered with fibrous nanocarbon. In the electrode material of the present invention, the base material is an aggregate of carbon fibers and spaces are formed between the carbon fibers, and thus, the carbon fibers present inside the base material can also be covered with fibrous nanocarbon.

The electrode material of the present invention preferably has high conductivity, and a volume resistivity before supporting a catalyst metal (that is, a volume resistivity of the carbon composite material) is preferably 10⁻⁸ to 10⁸ mQ·cm, more preferably 10⁻⁸ to 10⁴ mQ·cm, still more preferably 10⁻⁸ to 100 mQ·cm, and most preferably 10⁻⁸ to 10 mQ·cm. In the present specification, the volume resistivity can be measured using either a contact type or non-contact type electric resistance measuring device.

In the present specification, the fibrous nanocarbon is a fibrous carbon material having a diameter on the order of nanometers, has the same meaning as carbon nanofilaments (CNFs), and may be referred to as CNFs. The fibrous nanocarbon is a carbon material that has graphene as a constituent unit and has a fibrous structure formed by stacking the graphene. The fibrous nanocarbon has high crystallinity because the constituent unit thereof has a graphene-like structure, and unlike an amorphous carbon material such as activated carbon or carbon black, a structure thereof is not changed even by repeated use, which contributes to prolonging the life of power generation performance. In addition, since the fibrous nanocarbon has a fibrous structure formed by stacking graphene, graphene edges are innumerably present on a surface thereof, and the graphene edges serve as supporting sites of the catalyst metal. Therefore, particle diameter reduction and high dispersion of catalyst metal fine particles are promoted, and the number of electrode reaction sites can be increased. Note that the graphene stacked structure includes a cup-shaped graphene stacked structure, a coin-shaped graphene stacked structure, and the like, and the stacked structure can be formed depending on synthesis conditions of the fibrous nanocarbon. Therefore, the CNFs of the present invention are greatly different from a structure called a so-called carbon nanotube in that graphene edges are regularly exposed on the entire surface of the fibrous structure. In this research field, there is fibrous nanocarbon having an internal structure like a bamboo knot, which is referred to as a bamboo-like structure, but there is also a report claiming that this is a cup stacked structure. However, the fibrous nanocarbon actually has graphene edges to the extent that the fibrous nanocarbon should be classified as multi-layered carbon nanotubes, and an exposure state thereof is irregular and partial, which is significantly different from the CNFs structure provided by the present invention.

An average fiber diameter of the fibrous nanocarbon is preferably 5 to 300 nm, more preferably 10 to 100 nm, and still more preferably 10 to 40 nm. The fiber diameter of the fibrous nanocarbon can be measured from an SEM image obtained by a scanning electron microscope (SEM). For example, from about 10 to 20 SEM images observed at a magnification of about 100,000, about 5 pieces of fibrous nanocarbon are selected from each SEM image in a clear imaging state without overlapping, a fiber diameter of the selected fibrous nanocarbon is measured, and a histogram classified into classes of fiber diameter of 5 nm is created to determine an average fiber diameter. In Examples of the present invention, the fiber diameters obtained from the fiber diameter measurement result of about 100 CNFs synthesized by a contact reaction between a nickel catalyst and methane were distributed in a range of 15 nm to 30 nm in a case where a synthesis temperature was 450° C., and were distributed in a range of 20 nm to 40 nm in a case where the synthesis temperature was 550° C.

In the synthesis of fibrous nanocarbon, fibrous nanocarbon can be densely grown on the carbon fibers constituting the base material, and thus, fibrous nanocarbon can be formed into a thin layer on the surface of the carbon fiber. Therefore, unlike spherical fine particles having a size of 10 μm or more such as marimo carbon, the layer of fibrous nanocarbon formed on the surface of the carbon fiber can easily diffuse (supply) the raw material gas into the layer and diffuse (remove) the reaction product from the inside of the layer. In the electrode material of the present invention, a lower limit value of a thickness of the layer of the fibrous nanocarbon formed on the surface of the carbon fiber is preferably 0.1 μm or more, more preferably 0.5 μm or more, and still more preferably 1 μm or more. In addition, an upper limit value of the thickness of the layer of the fibrous nanocarbon formed on the surface of the carbon fiber is preferably 10 μm or less, more preferably 5 μm or less, and still more preferably 3 μm or less.

In the electrode material of the present invention, the amount of fibrous nanocarbon present per 1 g of the base material comprising carbon fibers is preferably 2 to 10,000 mg/g, more preferably 5 to 5,000 mg/g, and sill more preferably 10 to 500 mg/g. When the amount of fibrous nanocarbon present per 1 g of the base material comprising carbon fibers is within the above specified range, the fibrous nanocarbon can be formed into a thin layer on the surface of the carbon fiber.

In the electrode material of the present invention, the catalyst metal is supported on the fibrous nanocarbon. By supporting the catalyst metal on the fibrous nanocarbon covering the carbon fibers, the supported amount of the catalyst metal can be significantly increased as compared with the case of supporting the catalyst metal on the carbon fibers. In addition, marimo carbon is known as a catalyst support for fuel cells comprising CNFs. Marimo carbon is substantially formed of CNFs, and it is expected that a proportion of CNFs is significantly high as compared with the carbon composite material used in the present invention, and the supported amount of catalyst metal is naturally large. However, in practice, the carbon composite material used in the present invention can support more catalyst metals than marimo carbon. This is considered to be because, since marimo carbon has a large diameter of 10 μm or more, it is difficult to impregnate the entire marimo carbon with a stock solution of the catalyst metal, and the amount of catalyst metal supported cannot be increased. On the other hand, in the carbon composite material used in the present invention, it is considered that since the fibrous nanocarbon can be formed into a thin layer on the surface of the carbon fiber, the entire layer of fibrous nanocarbon can be sufficiently impregnated with the stock solution of the catalyst metal, and as a result, more catalyst metals can be supported than the carbon material formed of CNFs such as marimo carbon. Therefore, the electrode material of the present invention exhibits a high catalytic effect and is excellent in electrode performance.

In the electrode material of the present invention, the supported amount of catalyst metal is preferably 0.3 to 10 mass %, and more preferably 0.5 to 5 mass %, with respect to the total mass of the material comprising carbon fibers covered with fibrous nanocarbon (carbon composite material). Note that, in a case where the entire carbon fibers are not covered with fibrous nanocarbon, the catalyst metal can also be supported on the carbon fiber.

In the electrode material of the present invention, an average particle diameter of the catalyst metal is preferably 0.5 to 50 nm, more preferably 1 to 30 nm, and still more preferably 2 to 20 nm. The particle diameter of the catalyst metal can be measured by a transmission electron microscope (TEM). In a case where an image of the catalyst metal is not a circle, a maximum value of a distance between two points is defined as the particle diameter of the catalyst metal. In the present specification, an average value is determined from particle diameters of 50 or more catalyst metals.

The catalyst metal is appropriately selected depending on the type of fuel cell, examples thereof include platinum group metals such as platinum, palladium, rhodium, ruthenium, and osmium, and platinum or palladium is often used.

In the electrode material of the present invention, the carbon fibers covered with fibrous nanocarbon that supports a catalyst metal are preferably further covered with a proton conductive material. The proton conductive material is a material capable of transferring protons, and a material that can be used for an electrolyte constituting a fuel cell can be suitably used. For example, ionomers such as a fluorine-based ionomer and a hydrocarbon-based ionomer are preferable. The fluorine-based ionomer is an isomer containing a fluorine atom in a polymer skeleton, specific examples thereof include a perfluoroalkylsulfonic acid-based polymer, and DuPont's Nafion (registered trademark) can be suitably used. The hydrocarbon-based ionomer is a non-fluorine-based ionomer containing no fluorine atom in a polymer skeleton, and specific examples thereof include an ionomer in which a sulfonic acid group is introduced into an aromatic polymer such as polystyrene or aromatic polyether ketone. By covering carbon fibers covered with fibrous nanocarbon that supports a catalyst metal (catalyst-supported carbon fibers) with a proton conductive material, an electrode reaction can be performed even at a portion other than a contact interface with an electrolyte constituting a fuel cell, and a utilization rate of the supported catalyst metal can be improved. Furthermore, when a membrane electrode assembly is produced by covering catalyst-supported carbon fibers with a proton conductive material and directly pressure-bonding the covered catalyst-supported carbon fibers to an electrolyte membrane, the proton conductive material is a binding material that maintains adhesion between the carbon fibers and suppresses destruction of the carbon fibers, is also a reinforcing material, and can also be expected to play a role of a buffer. Here, the “carbon fibers covered with fibrous nanocarbon that supports a catalyst metal are covered with a proton conductive material” means that the entire or some of catalyst-supported carbon fibers are covered with a proton conductive material.

In order to leave spaces formed between carbon fibers even after a material comprising carbon fibers covered with fibrous nanocarbon that supports a catalyst metal (catalyst-supported carbon composite material) is covered with a proton conductive material, it is preferable to thinly cover the catalyst-supported carbon fibers with an appropriate amount of the proton conductive material. In the electrode material of the present invention, the amount of the proton conductive material is preferably 10 to 25 mass %, and more preferably 15 to 20 mass %, with respect to the total mass of the material comprising carbon fibers covered with fibrous nanocarbon that supports a catalyst metal.

The electrode material of the present invention uses a material comprising carbon fibers that allow easy diffusion (supply) of a raw material gas and diffusion (removal) of a reaction product as a base material, which can densely grow fibrous nanocarbon on the surface of the carbon fiber, and a catalyst metal can be supported on the fibrous nanocarbon in a highly dispersed manner. According to the electrode material of the present invention, with this structure, the utilization rate of the catalyst metal can be improved, and the supply of the raw material gas can be avoided from being a rate-limiting factor of a redox reaction. In addition, since drainage property is high, the drainage is not rate-limiting on the output side where a severe reaction occurs, and a voltage drop does not occur. The electrode material of the present invention contributes to a high output of a fuel cell.

In addition, the electrode material of the present invention can have a gas diffusion function (can be used as a member in which an electrode catalyst layer and a gas diffusion layer are integrated in a fuel cell), and does not need to separately prepare a gas diffusion layer, which contributes to downsizing of the fuel cell. In addition to eliminating the need to install a gas diffusion layer, the electrode material of the present invention is not a powder and can be stacked directly on the electrolyte membrane, and thus, it is possible to simplify the MEA production process.

In addition, in the electrode material of the present invention, the fibrous nanocarbon has high crystallinity because the constituent unit thereof has a graphene-like structure, and unlike an amorphous carbon material such as activated carbon or carbon black, a structure thereof is not changed even by repeated use, which contributes to prolonging the life of a fuel cell. In addition, graphene edges are innumerably present on the surface of the fibrous nanocarbon, and the graphene edges serve as supporting sites of the catalyst metal. Therefore, particle diameter reduction and high dispersion of catalyst metal fine particles are promoted, and the number of electrode reaction sites can be increased.

Next, a method for producing an electrode material of the present invention will be described.

An embodiment of the method for producing an electrode material of the present invention comprises a step of covering carbon fibers constituting a material comprising carbon fibers with fibrous nanocarbon, and a step of supporting a catalyst metal on the material comprising carbon fibers covered with fibrous nanocarbon (carbon composite material), and preferably further comprises a step of covering a material comprising carbon fibers covered with fibrous nanocarbon that supports a catalyst metal (catalyst-supported carbon composite material) with a proton conductive material.

The step of covering the carbon fibers constituting the material comprising carbon fibers with fibrous nanocarbon is a step of forming a material comprising carbon fibers covered with fibrous nanocarbon (carbon composite material), vapor phase synthesis of fibrous nanocarbon is preferably performed on the carbon fibers, and chemical vapor phase synthesis of fibrous nanocarbon using a contact reaction between hydrocarbon gas and a transition metal catalyst is more preferably performed. In the material comprising carbon fibers, spaces are formed between the carbon fibers, and gaps between the carbon fibers serve as paths for a solution or gas. Therefore, when the vapor phase synthesis method is used, fibrous nanocarbon can be densely grown so as to cover all carbon fibers one by one, and fibrous nanocarbon can be synthesized in a plane direction and a thickness direction of the material comprising carbon fibers.

In the chemical vapor phase synthesis of the fibrous nanocarbon, it is preferable that a solution containing transition metal ions is used, and a transition metal catalyst is supported in the form of fine particles on carbon fibers constituting the material comprising carbon fibers by an impregnation method. In order to reliably support the transition metal catalyst uniformly on the material comprising carbon fibers, it is preferable to repeatedly perform the impregnation method. Here, examples of the transition metal to be used include nickel (Ni), copper (Cu), palladium (Pd), zinc (Zn), cobalt (Co), and iron (Fe), and nickel is particularly preferable. When not only nickel is used alone as a catalyst, but also a catalyst containing nickel as a main component and, for example, copper added thereto at a molar ratio of about 20% is used, coin-stacked CNFs in which graphene sheets are stacked to form a fibrous structure are obtained. In a case where zinc is added to nickel, a diameter of a CNF is smaller than that in the case of only nickel, and CNFs having a cup stacked structure can be synthesized. In a case where cobalt is added to nickel, an exposure state of the graphene edge per unit length of the CNF surface can be adjusted in a direction that reduces it. As described above, synthesis of CNFs is performed using a multi-component catalyst in which nickel is a main component and a second element or a third element is further added, such that graphene edges can be controlled and disposed on the surface of the fibrous structure. The structure is completely different from that of so-called carbon nanotubes. As the name suggests, carbon nanotubes have a hollow structure formed by wrapping graphene sheets, and there are no graphene edges on a surface thereof. The so-called bamboo-like structure also has a different microstructure from the CNFs of the present invention. Bamboo-like is fibrous carbon in which a bamboo knot-like structure is formed inside a fibrous structure, and it can be said that graphene edges are exposed on the surface as compared with carbon nanotubes, but the number thereof is extremely small as compared with the CNFs of the present invention, and the bamboo-like structure has a structure close to a multi-layered carbon nanotube structure. As described above, the CNFs of the present invention uniformly control fine structures such as a cup stacked structure and a coin stacked structure by using a catalyst metal containing nickel as a main component and depending on conditions such as a reactive gas type and a synthesis temperature. Therefore, in the CNFs of the present invention, the graphene edges exposed on the surface are uniformly and regularly arranged in a longitudinal direction of the fibrous structure, and is greatly different from a tube structure in which the graphene edges are hardly exposed and a bamboo structure in which the graphene edges are small and the exposed state is not uniform. Examples of a solvent of the solution containing transition metal ions include ethanol and acetone in addition to pure water. It is preferable to support a transition metal catalyst on the carbon fiber and then dry the carbon fiber. The drying can be performed in air, a drying temperature is, for example, 300 to 400° C., and a drying time is, for example, 30 minutes to 90 minutes. Next, fibrous nanocarbon can be grown by a contact reaction between the transition metal catalyst supported on the carbon fiber and hydrocarbon gas, and therefore, a material comprising carbon fibers covered with fibrous nanocarbon (carbon composite material) can be formed. Here, examples of the hydrocarbon gas to be used include methane, ethane, and a mixed gas of methane and ethane. In addition, if necessary, a reaction auxiliary gas such as argon or hydrogen, a dilution gas, or the like can be appropriately mixed with the hydrocarbon gas. A temperature at the time of performing the contact reaction is, for example, 400 to 600° C., and preferably 450 to 550° C., and a reaction time is, for example, 30 minutes to 180 minutes. The contact reaction may be a fixed bed type or a fluidized bed type. In addition, before the contact reaction is performed, an annealing treatment may be performed on a material comprising carbon fibers that supports a transition metal catalyst. The annealing treatment is preferably performed in an inert gas such as argon (Ar), a treatment temperature is, for example, 350 to 450° C., and a treatment time is, for example, 30 minutes to 90 minutes.

The step of supporting the catalyst metal on the carbon composite material is a step of forming a material comprising carbon fibers covered with fibrous nanocarbon that supports a catalyst metal (catalyst-supported carbon composite material). This makes it possible to support catalyst metal fine particles on graphene edges that are innumerably present on the surface of the fibrous nanocarbon constituting the carbon composite material. For supporting the catalyst metal, it is preferable to use a solution containing catalyst metal ions and treat the carbon composite material in the solution by an impregnation method or a nanocolloid method. In order to reliably support the catalyst metal uniformly on the carbon composite material, it is preferable to repeat the operation in the case of the impregnation method, and it is preferable to examine the amount and concentration of reducing agent, an addition method, and a stirring method during the reaction in the case of the nanocolloid method to clarify optimization conditions. Examples of a solvent of the solution containing catalyst metal ions include a solution obtained by appropriately mixing ethanol, acetone, or the like mainly with pure water (ion-exchanged water). The obtained catalyst-supported carbon composite material may be subjected to a reduction operation in a hydrogen stream. It is preferable to perform the operation in an inert gas such as hydrogen or argon (Ar), a treatment temperature is, for example, 200 to 600° C. depending on the metal type, and a treatment time is, for example, 30 minutes to 60 minutes.

The step of covering the catalyst-supported carbon composite material with a proton conductive material is a step of covering carbon fibers covered with the fibrous nanocarbon that supports a catalyst metal with a proton conductive material. Therefore, an electrode reaction can be performed even at a portion other than a contact interface with the electrolyte constituting the fuel cell, and a utilization rate of the supported catalyst metal can be improved. The carbon fibers constituting the catalyst-supported carbon composite material can be covered with a proton conductive material by dropping the proton conductive material or by immersing in the proton conductive material. A solvent may be used for dropping of or immersion in the proton conductive material. The proton conductive material is used in an optimum amount according to a microstructure of the fibrous nanocarbon material.

Another aspect of the present invention is a membrane electrode assembly for fuel cells comprising a pair of electrode catalyst layers and an electrolyte membrane disposed between the electrode catalyst layers. In the present specification, the membrane electrode assembly for fuel cells is also referred to as “membrane electrode assembly of the present invention”.

In the membrane electrode assembly of the present invention, one of the pair of electrode catalyst layers is an electrode catalyst layer constituting an anode of a fuel cell, and the other one is an electrode catalyst layer constituting a cathode of the fuel cell. In the membrane electrode assembly of the present invention, at least one of the pair of electrode catalyst layers contains the electrode material of the present invention described above, and preferably, both of the pair of electrode catalyst layers contain the electrode material of the present invention described above. Since the electrode material of the present invention can have a gas diffusion function, the membrane electrode assembly of the present invention does not necessarily require a gas diffusion layer to be provided on the electrode catalyst layer. In a preferred embodiment of the membrane electrode assembly of the present invention, the electrode catalyst layer containing the electrode material of the present invention is an electrode catalyst layer having a gas diffusion function.

In the membrane electrode assembly of the present invention, the electrolyte membrane is preferably a proton conductive polymer membrane. The proton conductive material as described in the electrode material of the present invention can be used for a proton conductive polymer membrane. For example, it is preferable to use an electrolyte membrane comprising ionomers such as a fluorine-based ionomer and a hydrocarbon-based ionomer. Specific examples of the fluorine-based ionomer include a perfluoroalkylsulfonic acid-based polymer, and Nafion (registered trademark) manufactured by DuPont can be preferably used. Specific examples of the hydrocarbon-based ionomer include ionomers in which a sulfonic acid group is introduced into an aromatic polymer such as polystyrene or aromatic polyetherketone.

In the membrane electrode assembly of the present invention, since the electrode catalyst layer can be disposed on the electrolyte membrane by directly bonding the electrode material of the present invention to the electrolyte membrane, slurrying of the electrode catalyst and preparation and transfer of a thin film are not required, and the production process of the membrane electrode assembly (MEA) can be simplified. In addition, since the electrode material of the present invention can have a gas diffusion function, and it is not necessarily required to provide a gas diffusion layer on the electrode catalyst layer, the MEA production process is simplified from this point as well.

Still another aspect of the present invention is a fuel cell comprising a pair of electrode catalyst layers and an electrolyte disposed between the electrode catalyst layers. In the present specification, the fuel cell is also referred to as “fuel cell of the present invention”. The fuel cell of the present invention can be used as a fuel cell such as a polymer electrolyte fuel cell (PEFC), a phosphoric acid fuel cell (PAFC), an alkaline electrolyte fuel cell (AFC), a molten carbonate fuel cell (MCFC), a solid oxide fuel cell (SOFC), or a direct methanol fuel cell (DMFC), PEFC and DMFC are preferable, and PEFC is most preferable.

In an embodiment of the fuel cell of the present invention, at least one of the pair of electrode catalyst layers contains the electrode material of the present invention. In addition, in another embodiment of the fuel cell of the present invention, the membrane electrode assembly of the present invention is included.

In the fuel cell of the present invention, one of the pair of electrode catalyst layers is an electrode catalyst layer constituting an anode, and the other one is an electrode catalyst layer constituting a cathode. In the anode, oxidation of hydrogen usually occurs. In the cathode, reduction of oxygen usually occurs, and water is generated. Note that, in the case of DMFC, the same reaction is performed at the cathode, but at the anode, methanol is oxidized by supply of methanol and water, and carbon dioxide is generated.

In an embodiment in which at least one of the pair of electrode catalyst layers in the fuel cell of the present invention contains the electrode material of the present invention, it is preferable that both of the pair of electrode catalyst layers contain the electrode material of the present invention. The electrode catalyst layer containing the electrode material of the present invention is preferably an electrode catalyst layer having a gas diffusion function. In addition, in the embodiment, the electrolyte is preferably composed of an electrolyte membrane, and the electrolyte membrane is preferably a proton conductive polymer membrane. The proton conductive material as described in the electrode material of the present invention can be used for a proton conductive polymer membrane. For example, it is preferable to use an electrolyte membrane comprising ionomers such as a fluorine-based ionomer and a hydrocarbon-based ionomer. Specific examples of the fluorine-based ionomer include a perfluoroalkylsulfonic acid-based polymer, and Nafion (registered trademark) manufactured by DuPont can be preferably used. Specific examples of the hydrocarbon-based ionomer include ionomers in which a sulfonic acid group is introduced into an aromatic polymer such as polystyrene or aromatic polyetherketone.

In a case where the fuel cell of the present invention includes the membrane electrode assembly of the present invention, the pair of electrode catalyst layers in the fuel cell is a pair of electrode catalyst layers constituting the membrane electrode assembly of the present invention. In the embodiment, in the membrane electrode assembly of the present invention, at least one of the pair of electrode catalyst layers contains the electrode material of the present invention, preferably both of the pair of electrode catalyst layers contain the electrode material of the present invention, and here, the electrode catalyst layer containing the electrode material of the present invention is preferably an electrode catalyst layer having a gas diffusion function. In addition, in a case where the fuel cell of the present invention comprises the membrane electrode assembly of the present invention, the electrolyte of the fuel cell is an electrolyte membrane that constitutes the membrane electrode assembly of the present invention.

The fuel cell of the present invention preferably comprises a gasket in a case where the electrolyte has a portion not covered with the electrode catalyst layer. The gasket can be disposed on a surface of the electrolyte not covered with the electrode catalyst layer. In an embodiment, the fuel cell of the present invention further comprises a pair of gaskets, wherein the pair of gaskets are disposed so as to cover the surface of the electrolyte not covered with the pair of electrode catalyst layers. The gasket is preferably disposed along an outer periphery of the electrode catalyst layer. Various polymer films such as polyethylene terephthalate and polyamide can be used for the gasket.

The fuel cell of the present invention can comprise a pair of separators installed outside the pair of electrode catalyst layers, respectively. In a case where the fuel cell of the present invention comprises a pair of gaskets, the pair of separators can be disposed outside the pair of electrode catalyst layers and the pair of gaskets. An electrolyte, an anode, a cathode, and the like required for power generation are disposed between the pair of separators, and the separators can be used to partition the fuel cell. The separator is preferably composed of a conductive flat plate, and a carbon-based material or a metal-based material such as steel, stainless steel, titanium, or aluminum can be used.

The fuel cell of the present invention can comprise a pair of current collector members formed outside the pair of electrode catalyst layers, respectively. The pair of current collector members are preferably disposed outside the pair of separators. The current collector member is a member for extracting electricity generated by an electrode reaction and is preferably composed of a conductive flat plate, and a metal-based material such as steel, stainless steel, titanium, or aluminum can be used for the current collector member.

The fuel cell of the present invention can comprise a pair of fastening members formed outside the pair of electrode catalyst layers, respectively. The pair of fastening members are preferably disposed outside the pair of current collector members, and an insulating member is preferably disposed between the current collector member and the fastening member. The fastening member is a member for fastening members such as an electrolyte and an electrode between the fastening members and is preferably composed of a flat plate, and a metal-based material such as steel, stainless steel, titanium, or aluminum can be used for the fastening member.

In the fuel cell of the present invention, a structure comprising an electrolyte, an electrode catalyst layer, and as necessary, a gasket, a separator, a current collector member, a fastening member, and the like is used as a cell constituent member, and a plurality of cell constituent members can be integrated in parallel or in series in order to obtain a target voltage and current. A single cell constituent member may be referred to as a fuel cell, a fuel cell comprising a plurality of cell constituent members may be referred to as a fuel cell stack, and a fuel cell comprising a plurality of stacks may be referred to as a fuel cell module.

### EXAMPLES

Hereinafter, the present invention will be described in more detail with reference to Examples, but the present invention is not limited to the following Examples.

### Reference Example: Synthesis and Evaluation of Carbon Composite Material

### (Experiment)

A CFP (manufactured by Toray Industries, Inc., TGP-H-060, 0.19 mm thick, monofilament diameter: about 6 μm) was subjected to a heat treatment in air at 350° C. for 30 minutes as a pre-treatment. The CFP was cut into a size of 10 mm×30 mm to prepare a base material. A process of supporting a Ni catalyst on the base material was as follows. First, the base material was impregnated with an impregnation solution in which Ni(NO₃)₂.6H₂O was dissolved in ethanol for 30 minutes, and the base material was removed from the solution and dried in air at 350° C. for 60 minutes. The operation was repeated twice, and for the second impregnation, the surface of the base material facing up during the first impregnation was placed to be face down into the solution. Therefore, a base material that supported a Ni catalyst (Ni/CFP) was obtained. The Ni/CFP was introduced into a fixed-bed flow reaction device, and annealing was performed at 400° C. for 60 minutes in an Ar gas atmosphere for decomposing and removing a nitrate radical contained in the impregnation solution and forming Ni catalyst fine particles. After completion of the annealing, the temperature was raised to a reaction temperature (500° C.) in Ar, and once the temperature reached 500° C., the Ar gas was replaced with CH₄ gas, and a contact reaction was performed for 60 minutes to synthesize a carbon composite material in which carbon fibers constituting the CFP were covered with CNFs (CNFs/CFP).

### (Results and Considerations)

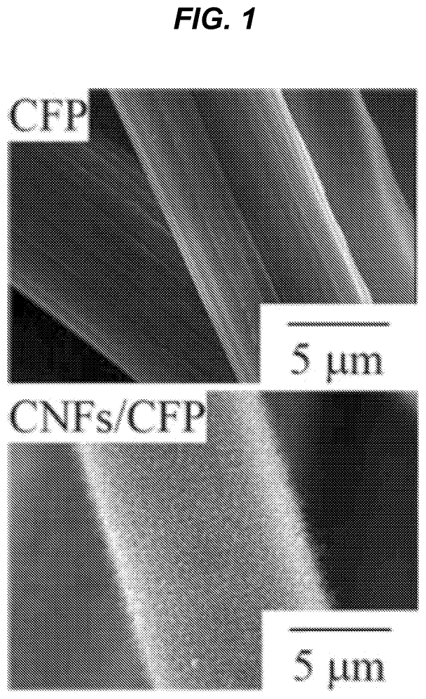

FIG. 1 illustrates an SEM image of a CFP (upper side) and an SEM image of CNFs/CFP (lower side). From the SEM image of CNFs/CFP, it was found that CNFs were uniformly deposited on the surface of the carbon fiber. In the present experiment, it was considered that since the transition metal catalyst was uniformly supported in an in-plane direction and a thickness direction of the CFP by two impregnations, the carbon fibers constituting the CFP were uniformly covered with CNFs. The present experiment was repeated several tens of times, and a carbon composite material in which carbon fibers were uniformly covered with fibrous nanocarbon was synthesized with excellent reproducibility.

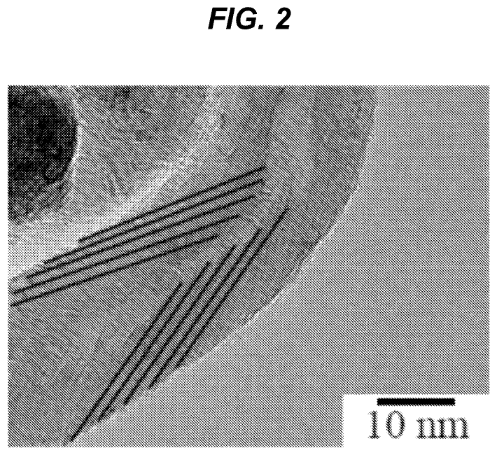

FIG. 2 illustrates a TEM image of CNFs. From the TEM image of the CNFs, it can be seen that the microstructure of the CNFs has a cup-shaped graphene stacked structure.

### Example 1: Synthesis and Evaluation of Catalyst-Supported Carbon Composite Material

### (Experiment)

A CFP (manufactured by Toray Industries, Inc., TGP-H-060, 0.19 mm thick, monofilament diameter: about 6 μm) was subjected to a heat treatment in air at 350° C. for 30 minutes, the CFP was cut into a size of 1 cm×3 cm, and the cut CFP was used as a base material. The Ni catalyst was supported by an impregnation method using Ni nitrate hexahydrate as a catalyst precursor and ethanol as a solvent. The base material after impregnation was dried in air at 350° C. for 60 minutes to obtain Ni/CFP. CNFs were synthesized using a fixed-bed flow reaction device. First, the Ni/CFP was introduced into the device, and an annealing treatment was performed in Ar at 400° C. for 60 minutes. Subsequently, the temperature was raised to and maintained at the synthesis temperature to synthesize CNFs. CH₄ was used as a reaction gas, the synthesis time was 60 minutes, and the synthesis temperature was set in a range of 450° C. to 600° C. to perform synthesis. Pd particles were supported on the obtained CNFs/CFP by an impregnation method using palladium acetate as a catalyst precursor and acetone as a solvent. The CNFs/CFP after impregnation was naturally dried and then heat-treated in Ar at 250° C. for 30 minutes to obtain Pd/CNFs/CFP as a catalyst-supported carbon composite material. The morphology of the sample was examined using a scanning electron microscope (SEM), and the electric resistance was examined using a four-probe method.

Note that, although not illustrated, it was confirmed by a transmission electron microscope (TEM) that the CNFs had a cup-shaped graphene stacked structure, as in Reference example.

### (Results and Considerations)

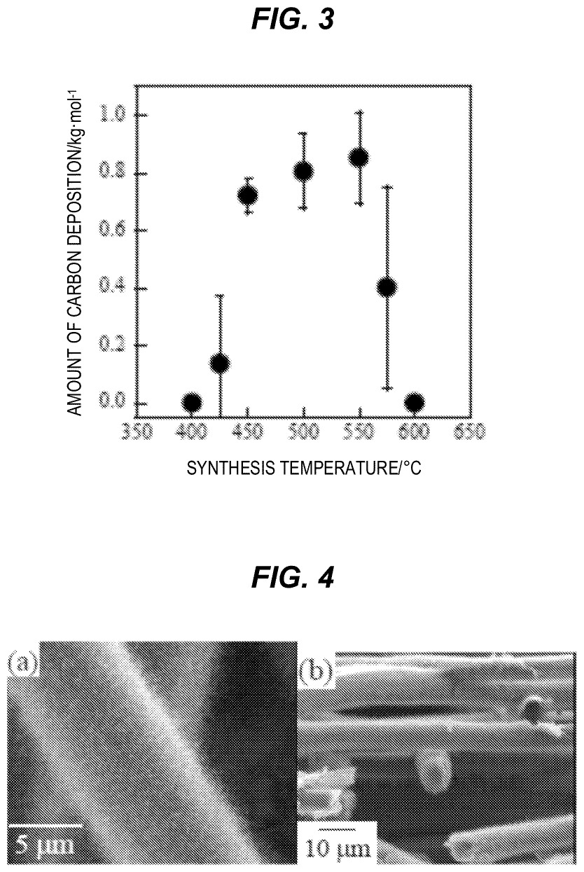

FIG. 3 illustrates a relationship between the amount of fibrous nanocarbon deposition (carbon deposition amount) and a synthesis temperature. As can be seen from FIG. 3, the deposition of fibrous nanocarbon was stably performed at 450° C. to 550° C. About 5 mg of fibrous nanocarbon was deposited with respect to about 25 mg of the CFP having a size of 1 cm×3 cm, and the mass of the CNFs/CFP was increased by about 20% as compared with the mass of the CFP. In a case where this material was used as an electrode, the deposition amount of CNFs was 1.7 mg per 1 cm² of an electrode area.

FIG. 4 illustrates SEM images of the CNFs/CFP. FIG. 4(a) illustrates a surface of the CNFs/CFP, and FIG. 4(b) illustrates a cross section of the CNFs/CFP. As can be seen from FIG. 4(a), the CNFs grew densely and were generated so as to uniformly cover the carbon fibers constituting the CFP. In addition, as can be seen from FIG. 4(b), CNFs were also generated in a thickness direction of the CFP, and the entire CFP was covered with the CNFs. In this case, a thickness of the layer of CNFs covering the carbon fibers was about 2 μm.

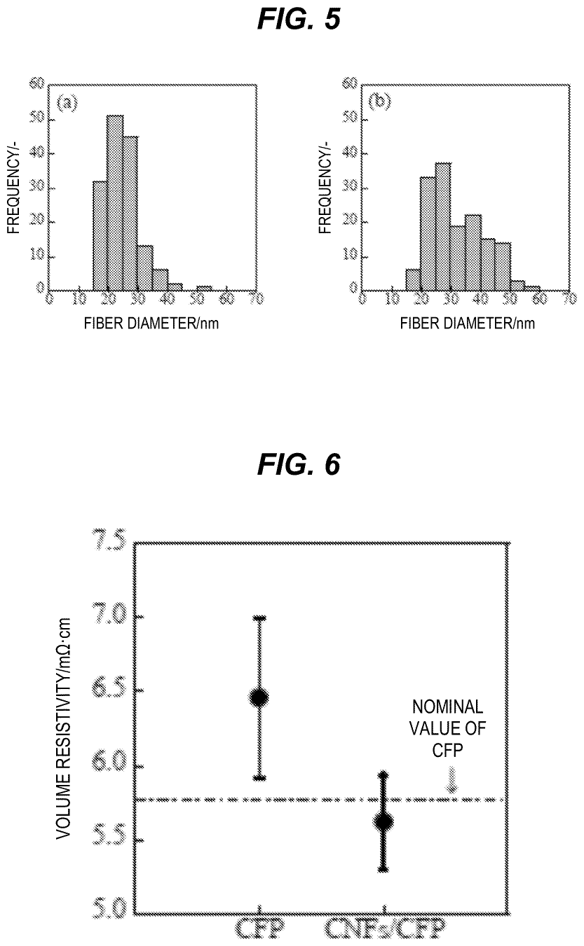

FIG. 5 illustrates fiber diameter distributions of CNFs synthesized at 450° C. and 550° C. FIG. 5(a) is the case of 450° C. and FIG. 5(b) is the case of 550° C. Fiber diameters of the CNFs synthesized at 450° C. were mostly distributed in a range of 15 nm to 30 nm. On the other hand, fiber diameters of the CNFs synthesized at 550° C. were mostly distributed in a range of 20 nm to 40 nm. In the case of 550° C., the distribution of the fiber diameters spread to the larger side of the fiber diameter than in the case of 450° C., and the CNFs was also present at a fiber diameter of 40 nm or more which was hardly observed at 450° C. It is known that the fiber diameters of the CNFs are caused by the size of the transition metal catalyst (N. M. Rodriguez; J. Mater. Res., 8, 3233 (1993)), and it is considered that sintering of the transition metal catalyst occurred on the high temperature side, and the fiber diameters of the CNFs increased.

FIG. 6 illustrates volume resistivities of CFP and CNFs/CFP obtained by measurement in a plane direction. The volume resistivity of the CFP was about 6.0 mQ·cm to 7.0 mQ·cm. On the other hand, the volume resistivity of the CNFs/CFP was about 5.3 mQ·cm to 6.0 mQ·cm, and the volume resistivity decreased by synthesizing CNFs. It was suggested that a nominal value of the volume resistivity of the CFP was 5.8 mQ·cm, and a value of the CNFs was equal to or lower than that of the CFP.

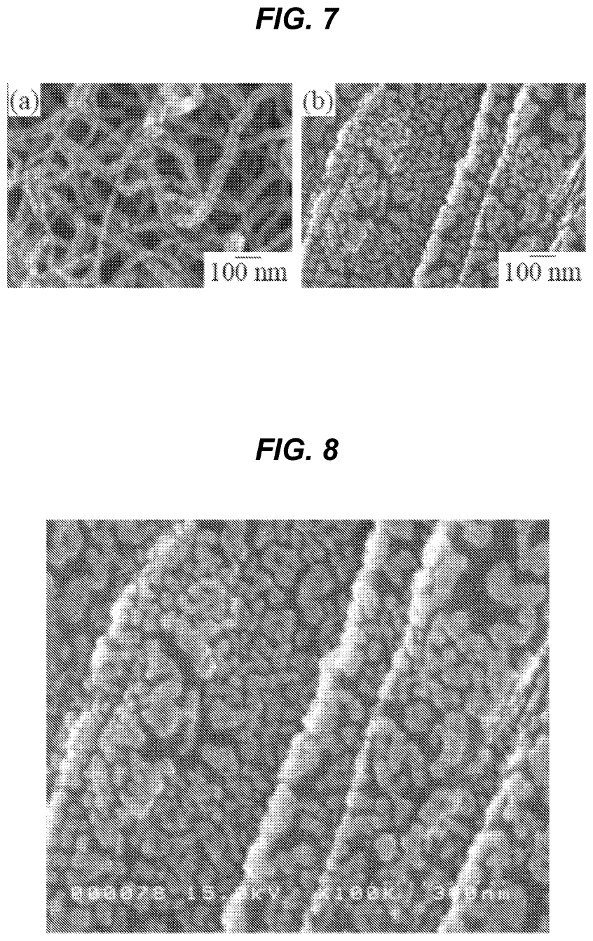

FIG. 7 illustrates an SEM image of Pd/CNFs/CFP as a catalyst-supported carbon composite material (a) and an SEM image of Pd/CFP in which palladium is supported on CFP (b). About 0.9 mass % of Pd with respect to CNFs/CFP was supported on the Pd/CNFs/CFP. Palladium particles having a particle diameter of about 5 nm to 20 nm were observed on the surface of the CNFs. As for Pd/CFP, Pd was supported on CFP in the same manner as the case of Pd/CNFs/CFP. About 0.3 mass % of Pd with respect to CFP was supported on the CFP, the size of the Pd particles was 100 nm to 200 nm, and the Pd particles were up to about 40 times larger than in the case of Pd/CNFs/CFP. More Pd was supported on CNFs/CFP than CFP, and further the size of the Pd particles decreased.

### SUMMARY

In a case where Ni was used as a transition metal catalyst and CH₄ was used as a reaction gas, CNFs/CFP was stably synthesized at 450° C. to 550° C. It was suggested that a fiber diameter of CNFs can be controlled by the synthesis temperature. Furthermore, the CNFs/CFP had a smaller electrical resistance than the CFP, and the supported Pd particles were set to be smaller.

### Example 2: Palladium Support on CFP and CNFs/CFP

### (Experiment)

100 mg of palladium acetate was weighed and dissolved in 12 mL of acetone to prepare a palladium solution. 5 mL of the prepared palladium solution was added to a petri dish having an inner diameter of 3 cm and a height of 1.5 cm, and the CFP and CNFs/CFP cut into 1 cm square were immersed therein. Note that TGP-H-060 (0.19 mm thick) manufactured by Toray Industries, Inc. was used as a CFP, and CNFs/CFP synthesized in Experimental Example 1 was used as CNFs/CFP. After 60 minutes, the CFP and CNFs/CFP were taken out, placed on a quartz boat, and naturally dried for 2 hours. After natural drying, the dried CFP and CNFs/CFP were introduced into a fixed-bed flow reaction device, and annealing was performed in Ar at 250° C. for 60 minutes. A weight of palladium was determined from a change in weight before impregnation and after impregnation and annealing. The morphology of the prepared sample was evaluated by a scanning electron microscope (SEM).

Note that, although not illustrated, it was confirmed by a transmission electron microscope (TEM) that the CNFs had a cup-shaped graphene stacked structure, as in Reference example.

### (Results)

Tables 1 and 2 show CFP and CNFs/CFP before and after impregnation and supported amounts of palladium. In the case of the CFP, the mass increased by 0.0232 mg after impregnation, and 0.281 mass % of palladium with respect to the base material (CFP) was supported on the base material (CFP). In the case of the CNFs/CFP, the mass increased by 0.0918 mg after impregnation, and 0.879 mass % of palladium with respect to the composite carbon material (CNFs/CFP) was supported on the composite carbon material (CNFs/CFP). The mass of CNFs contained in the composite carbon material (CNFs/CFP) was 1.3928 mg, and the mass of palladium with respect to the CNFs was 6.183 mass %. The CNFs/CFP supported 0.0686 mg more palladium than the CFP.

TABLE 1
Supported amount of palladium (CFP)

| Before impregnation | 8.2357 mg |
|---|---|
| After impregnation | 8.2589 mg |
| Mass of palladium | 0.0232 mg |
| Supported amount | 0.281% |

In Table 1, the “before impregnation” represents the mass of CFP before impregnation with the palladium solution, the “after impregnation” represents the mass of Pd/CFP after impregnation with the palladium solution and annealing treatment, the “mass of palladium” represents the mass of palladium supported on CFP, and the “supported amount” represents the supported amount (mass %) of palladium with respect to the mass of CFP.

TABLE 2
Supported amount of palladium (CNFs/CFP)

| Before impregnation | 10.3466 mg |
|---|---|
| After impregnation | 10.4384 mg |
| Mass of palladium | 0.0918 mg |
| Supported amount on CNFs/CFP | 0.879% |
| Mass of CNFs | 1.3928 mg |
| Supported amount on CNFs | 6.183% |

In Table 2, the “before impregnation” represents the mass of CNFs/CFP before impregnation with the palladium solution, the “after impregnation” represents the mass of Pd/CNFs/CFP after impregnation with the palladium solution and annealing treatment, the “mass of palladium” represents the mass of palladium supported on CNFs/CFP, the “supported amount on CNFs/CFP” represents the supported amount (mass %) of palladium with respect to the mass of CNFs/CFP, the “mass of CNFs” represents the mass of CNFs contained in CNFs/CFP, and the “supported amount on CNFs” represents the supported amount (mass %) of palladium with respect to the mass of CNFs.

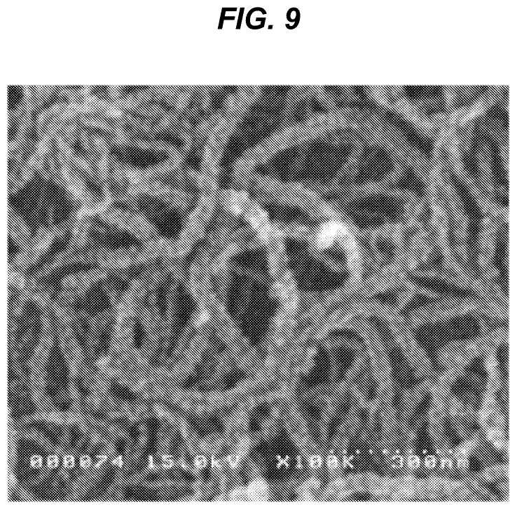

FIG. 8 illustrates an SEM image of Pd/CFP, and FIG. 9 illustrates an SEM image of Pd/CNFs/CFP. As can be seen from FIG. 8, Pd particles having a diameter of about 90 nm were supported on the CFP so as to cover the surface of the carbon fiber. In addition, as can be seen from FIG. 9, in CNFs/CFP, Pd particles having a diameter of about 5 nm to 20 nm were present on the surface of CNFs, and the Pd particles were smaller than CFP.

### Example 3: Comparison of Reactivities of Pd/CNFs/CFP and Pd/CFP with Hydrogen

### (Experiment)

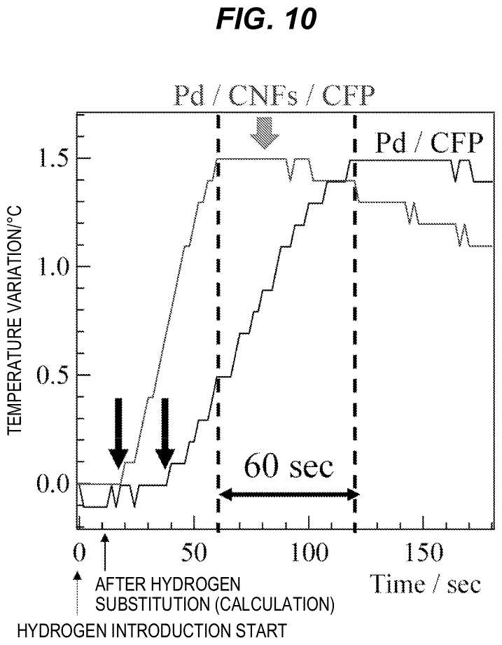

Reactivity with hydrogen was investigated using Pd/CFP and Pd/CNFs/CFP. The support of Pd was performed by a sputtering method, unlike Example 2. The same material as that used in Example 2 was used as a CFP. Synthesis of CNFs on CFP was performed under the same conditions as in Example 2 to obtain CNFs/CFP. Hydrogen gas was fed at 100 sccm (100 cc per minute) at atmospheric pressure into a measurement container filled with nitrogen gas, and a K thermocouple was brought close to each of Pd/CFP and Pd/CNFs/CFP to measure a change in temperature. The results are illustrated in FIG. 10.

### (Results)

As can be seen from FIG. 10, Pd/CNFs/CFP is more likely to react with hydrogen than Pd/CFP. That is, the reaction starts earlier in the Pd/CNFs/CFP than in the Pd/CFP, and the reaction rate is also faster. The reason for this is considered to be that the growth of CNFs on the CFP increases the number of active sites due to miniaturization of Pd. Since the support of Pd is performed by sputtering, there is no Pd in the thickness direction of the CNFs/CFP as compared with the impregnation method or the like, and it is not a result of utilizing the entire thickness of the CNFs/CFP, but a significant change occurs only in the vicinity of the surface. Note that the sputtering amount of Pd is about 40 nm (about 0.5 g/m² in terms of mass) in terms of film thickness.

1. An electrode material for fuel cells, the electrode material comprising carbon fibers, wherein the carbon fibers are carbon fibers covered with fibrous nanocarbon that supports a catalyst metal.

2. The electrode material for fuel cells according to claim 1, wherein the carbon fibers covered with fibrous nanocarbon that supports a catalyst metal are further covered with a proton conductive material.

3. A membrane electrode assembly for fuel cells, comprising: a pair of electrode catalyst layers, and an electrolyte membrane disposed between the electrode catalyst layers, wherein at least one of the pair of electrode catalyst layers contains the electrode material according to claim 1 or 2.

4. The membrane electrode assembly according to claim 3, wherein the electrolyte membrane is a proton conductive polymer membrane.

5. A fuel cell comprising: a pair of electrode catalyst layers, and an electrolyte disposed between the electrode catalyst layers, wherein at least one of the pair of electrode catalyst layers contains the electrode material according to claim 1 or 2.

6. A fuel cell comprising the membrane electrode assembly according to claim 3 or 4.

7. The fuel cell according to claim 5 or 6, wherein the electrode catalyst layer containing the electrode material is an electrode catalyst layer having a gas diffusion function.
